(19) United States
(12) Patent Application Publication
(10) Pub. No.: US 2020/0253231 A1
(43) Pub. Date: Aug. 13, 2020

(54) RICE MILK USING RICE PROTEIN AND METHOD FOR PREPARING THEREOF

(71) Applicant: Industry Academic Cooperation Foundation Jeonnam State University, Jeollanam-do (KR)

(72) Inventors: Jae Hun JEONG, Gwangju (KR); Soon Chang CHO, Daejeon (KR); Sang Jun KIM, Gwangju (KR); Dong Wan SEO, Jeollanam-do (KR); Ra Young JO, Gwangju (KR); Kyung Soo PARK, Jeollanam-do (KR); Jin Su JEONG, Jeollanam-do (KR)

(21) Appl. No.: 16/641,412

(22) PCT Filed: Nov. 11, 2019
(86) PCT No.: PCT/KR2019/015220

§ 371 Date: Feb. 24, 2020

(30) Foreign Application Priority Data
Dec. 13, 2018 (KR) 10-2018-0160476

(51) Int. Cl. A23C 11/10; A23L 29/00; A23L 33/105

(52) U.S. Cl. CPC A23C 11/10; A23L 33/105; A23L 29/035; A23L 29/06

(57) ABSTRACT

A rice milk according to an embodiment of the present invention includes a mixture of rice protein powder and rice enzyme digestion extract concentrate in purified water. The rice milk using rice protein is suitable for allergy-sensitive elderly and infants to drink and also provides functionality to stressed adults because it has milk properties, high nutritional value and good digestion by mixing rice enzyme decomposition extract obtained by digesting rice starch and rice protein with subsidiary ingredients. In addition a method for preparing a rice milk using rice protein according to an embodiment of the present invention includes a first enzymatic digestion step, a second enzymatic digestion step, a filtration step, a rice protein powdering step, and a rice enzyme extract saccharification solution concentration step.

### TECHNICAL FIELD

The present invention relates to a rice milk using rice protein and a method for preparing thereof, and more particularly, to a rice milk using rice protein and a method for preparing thereof which are suitable for allergy-sensitive elderly and infants to drink and also provide functionality to stressed adults because it has milk properties, high nutritional value and good digestion by mixing rice enzyme decomposition extract obtained by digesting rice starch and rice protein with subsidiary ingredients.

### BACKGROUND TECHNOLOGY OF THE INVENTION

Cereals are the world's most important agricultural products, accounting for more than 60% of the total calories, and are particularly important sources of protein in Asia. Among the grains, rice, along with wheat and corn, are the most important grains, accounting for over 75% of the world's grain consumption. However, due to the protein deficiency of rice, rice has a limit in the nutritional supply of infants and women, and thus there is a limit to continuously improving rice consumption.

In addition, due to the change in grain consumption caused by the change in the trend of domestic food consumption, the price of rice fell due to the decrease in consumption compared to domestic rice production, which caused a decrease in farm income. Accordingly, the development of new food materials using rice and the development of high value rice-related products are absolutely necessary.

Recently, rice protein extracted from rice is relatively low in protein content, but quantitative and qualitative attention is being refocused on rice protein as a good source of protein, thus approaching the market as a new food material.

Soy and wheat proteins and milk proteins are known to be allergens and have been reported to contain allergens even when hydrolyzed. Accordingly, regulations of the US Food and Drug Administration (FDA) and European Food Safety Agency (EU EFSA) require that these proteins be labeled on food packaging when used in food.

On the other hand, rice is the most consumed grain in Asia, and contains relatively low hypoallergenic protein, which can be used as a raw material for natural flavoring. In addition, rice can be used to develop foods for infants and young children whose immune systems are not fully established, and can be used for foods that can prevent immune diseases including Atopic Dermatitis.

Despite this, except for the Republic of Korea Patent Publication No. 10-2013-0060996(2013.06.10, Method for Preparing Natural Fermentation Condiment Using Rice Protein) and Republic of Korea Patent Registration No. 10-1873225(2018, Jun. 26, Manufacturing method for a seasoning of allergy-free natural flavoring materials comprising enzymatic lysate of rice bran and rice protein and manufactured therefrom), there is almost no development of a functional food that can be easily ingested using rice protein.

In particular, the product using the rice protein relates to the seasoning and seasoning material added to the cooking of the food, there is a limit to the daily intake of the components of the functionality of the rice protein.

### CONTENT OF INVENTION

### Problem to be Solved

The present invention has been made in view of the above, the object of the present invention is to provide a rice milk using rice protein and a method for preparing thereof which are suitable for allergy-sensitive elderly and infants to drink and also provide functionality to stressed adults because it has milk properties, high nutritional value and good digestion by mixing rice enzyme decomposition extract obtained by digesting rice starch and rice protein with subsidiary ingredients.

### Solution to Problem

In order to achieve the above object, a rice milk using rice protein according to the present invention is characterized in that the mixture of rice protein powder and rice enzyme digestion extract concentrate in purified water.

In addition, a rice milk using rice protein according to the present invention is characterized in that enzymatic extract of kelp, seaweed and bamboo leaf, fructooligosaccharide, soy lecithin, vegetable cream, mixed lactobacillus powder, refined salt, citric acid and sodium bicarbonate were added to the mixture of rice protein powder and rice enzymatic digestion extract concentrate in purified water.

In addition, a rice milk using rice protein according to the present invention is characterized in that purified water 80wt %, rice protein 6wt %, rice enzyme extract concentrate 10wt %, enzymatic extract of kelp, seaweed and bamboo leaf 0.4 wt %, fructooligosaccharide 0.6 wt %, soy lecithin 2 wt %, vegetable cream 0.3 wt %, mixed lactobacillus powder 0.15 wt %, refined salt 0.15 wt %, citric acid 0.2 wt %, and sodium hydrogencarbonate 0.2 wt % are mixed and added.

In addition a method for preparing a rice milk using rice protein of any one of claims 1 to 3 comprising: the first enzymatic digestion step (S10) of mixing rice(powder) with water of 3 to 5 times the weight(mass) of water and 0.3% α-amylase by weight of the substrate(rice), and then enzymatically digesting at 90°0 C. for 1 hour to prepare the said rice protein powder and rice enzyme decomposition extract concentrate, the second enzymatic digestion step (S20) of cooling the blended product after the said first enzymatic digestion step to 50° C., followed by enzymatic digestion for about 3.5 hours at a temperature of 50° C. by adding 0.5% glycosylase to the weight of the substrate(rice powder),

the filtration step (S30) of inactivating the enzyme of the secondary enzymatically degraded formulation at a temperature of 90° C. for about 0.5 hour (30 minutes), and then filtering the enzyme-inactivated formulation through a filter cloth to separate the sludge(rice protein) and the filtrate(sugar solution), the rice protein powdering step (S40) of homogenizing the sludge obtained by the said filtration step and then drying to obtain rice protein powder, the rice enzyme extract saccharification solution concentration step (S50) of concentrating and sterilizing the filtrate obtained by filtration in the said filtration step to obtain a rice enzyme decomposition extract concentrate.

### Effects of the Invention

According to an embodiment of the present invention, the present invention has the advantage of producing a rice milk which are suitable for allergy-sensitive elderly and infants to drink and also provide functionality to stressed adults because it has milk properties, high nutritional value and good digestion by mixing rice enzyme decomposition extract obtained by digesting rice starch and rice protein with subsidiary ingredients.

### BRIEF DESCRIPTION OF THE DRAWINGS

FIG. 1 is a flow diagram illustrating a method of producing a rice milk using rice protein according to an embodiment of the present invention.

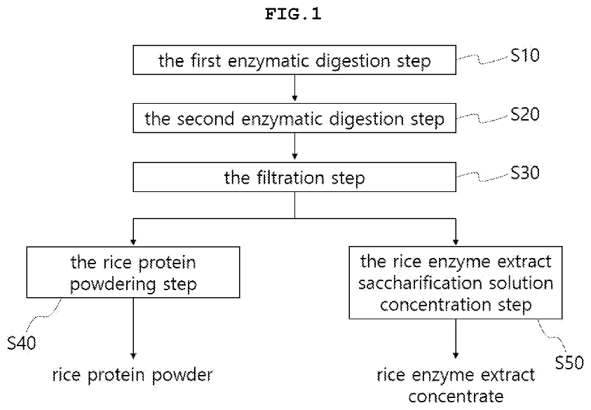

### SPECIFIC CONTENTS TO CARRY OUT INVENTION

Hereinafter, with reference to the drawings and embodiments will be described in more detail a rice milk using rice protein and a method for preparing thereof.

The present invention relates to a technique for preparing a rice milk product having a milk property by mixing the rice enzymatic extract and the rice protein obtained by decomposing rice starch with an enzyme with subsidiary materials such as prebiotic.

### EXAMPLE 1

### Extraction of Rice Protein

A: first enzymatic digestion step (S10)

Rice is enzymatically decomposed about 1 hour at a temperature of 90° C. by mixing with water of 3 to 5 times the weight of rice and 0.3% α-amylase by weight of rice.

B: secondary enzymatic digestion step (S20)

The formulation after the first enzymatic digestion step is cooled to 50° C., and then enzymatically decomposed about 3.5 hours at a temperature of 50° C. by adding 0.5% of saccharogenic amylase to the weight of the substrate (rice).

C: filtration step (S30)

The enzyme of the second enzymatically decomposed compound is inactivated at a temperature of 90° C. for about 0.5 hours (30 minutes), and the enzyme-inactivated compound is separated by a filter cloth into a sludge (rice protein) and a filtrate (sugar solution).

D: rice protein powdering step (S40)

The sludge obtained by filtration in the said filtration step is homogenized and then dried (freeze drying or spray drying) to obtain rice protein powder.

E: rice enzyme extract saccharification solution concentration step (S50)

The filtrate obtained by filtration in the said filtration step is concentrated and sterilized to obtain a rice enzyme decomposition extract concentrate.

Table 1 below summarizes the nutritional composition of rice protein powder and rice (white rice, brown rice) obtained through the above process, and Table 2 summarizes the constituent amino acid content of the rice protein powder.

TABLE 1

| Nutrient | White rice(100 g) | Rice protein powder |
|---|---|---|
| | | (100 g) |
| Carbohydrate | 80 | 34.77 |
| (g) | Dietary Fiber (1.30 g) | Dietary Fiber |
| | | (1.55 g) |
| Protein (g) | 7.10 | 54.50 |
| Fat (g) | 0.66 | 4.18 |
| Calorie (Kcal) | 130 | |

TABLE 2

| Constituent amino acids | Content (mg/100 g) |
|---|---|
| Tyrosine | 2150.46 |
| Glycine | 2462.46 |
| Serine | 2852.46 |
| Alanine | 3025.08 |
| Glutamic acid | 9410.15 |
| Lysine | 1529.08 |
| Leucine | 4361.38 |
| Methionine | 787.08 |
| Valine | 2749.69 |
| Arginine | 4317.23 |
| Aspartic acid | 4848.77 |
| Isoleucine | 1932.77 |
| Threonine | 1960.31 |
| Phenylalanine | 2874.31 |
| Proline | 2345.85 |
| Histidine | 1222.31 |
| Cystine | 304.93 |
| Tryptophan | 250.47 |

### EXAMPLE 1

### Preparation of Rice Protein Milk

The rice protein powder and the rice enzyme decomposition extract concentrate isolated in the said Example 1 were used as the main raw materials, and these were mixed with the following sub raw materials to prepare a rice milk composition.

Main raw materials: Rice enzyme digestion extract concentrate (rice enzyme digestion saccharification solution), rice protein powder, prebiotic

Side ingredients: emulsifier(soybean lecithin), lactic acid bacteria, purified salt, citric acid, sodium hydrogen carbonate

Other: purified water

As the prebiotic, an enzymatic digestion extract of kelp, seaweed and bamboo leaf is used. The said enzymatic digestion extract of kelp, seaweed and bamboo leaves is the enzymatic digestion extract which to the mixture of kelp: laver: bamboo leaf=2:1:1 (weight ratio), 0.5% of the enzyme (VISCOZYME, FUNGAMYL) by weight of the mixture was added, followed by enzymatic digestion and extraction at 50° C. for 3 hr.

Table 3 below summarizes the mixing ratio of the rice milk composition using the rice protein.

Table 4 summarizes the nutritional components of the rice protein milk prepared as described above.

TABLE 3

| | | Compounding | |
|---|---|---|---|
| No. | Raw material | content (g) | Remarks |
| 1 | Purified water | 80 | |
| 2 | Rice protein | 6 | Main raw |
| | | | material |
| 3 | Rice enzymatic | 10 | Main raw |
| | extraction | | material |
| | concentrate | | |
| 4 | Enzymatic digestion | 0.4 | Prebiotic |
| | extract of kelp, | | |
| | seaweed and bamboo | | |
| | leaf | | |
| 5 | Fructooligosaccharide | 0.6 | Prebiotic |
| 6 | Soy lecithin | 2 | Natural |
| | | | emulsifiers |
| 7 | Vegetable cream | 0.3 | |
| 8 | Lactobacillus | 0.15 | |
| | Blended Powder | | |
| 9 | Refined salt | 0.15 | |
| 10 | Citric acid | 0.2 | pH |
| | | | adjustment |
| 11 | Sodium hydrogen | 0.2 | pH |
| | carbonate | | adjustment |
| | Total | 100 | |

TABLE 4

| Nutrients | Unit | Content |
|---|---|---|
| carbohydrate | g/100 ml | 7.6 |
| Crude protein | g/100 ml | 3.8 |
| Crude fat | g/100 ml | 0.1 |

Rice milk using a rice protein described above and shown in the drawings and a method of manufacturing the same are just one embodiment for carrying out the present invention, and should not be construed as limiting the technical spirit of the present invention. The scope of protection of the present invention is defined only by the matters set forth in the claims below. And modified and modified embodiments without departing from the spirit of the invention will be within the scope of the invention as long as it will be apparent to those skilled in the art.

1. A rice milk comprising a mixture of a rice protein powder and a rice enzyme digestion extract concentrate in purified water.

2. The rice milk of claim 1, wherein the mixture further comprises an enzymatic extract of kelp, seaweed and bamboo leaf, fructooligosaccharide, soy lecithin, vegetable cream, mixed lactobacillus powder, refined salt, citric acid and sodium bicarbonate.

3. The rice milk of claim 2, wherein the mixture comprises the purified water 80 wt %, the rice protein powder 6 wt %, the rice enzyme extract concentrate 10 wt %, the enzymatic extract of kelp, seaweed and bamboo leaf 0.4 wt %, the fructooligosaccharide 0.6 wt %, the soy lecithin 2 wt %, the vegetable cream 0.3 wt %, the mixed lactobacillus powder 0.15 wt %, the refined salt 0.15 wt %, the citric acid 0.2 wt %, and the sodium hydrogencarbonate 0.2 wt % are mixed and added.

4. The rice milk of claim 1, wherein the rice protein powder and the rice enzyme digestion extract concentrate are prepared by a process comprising:
a first enzymatic digestion step of preparing a mixture comprising a substrate comprised of rice, water and α-amylase, wherein a weight of the water is 3 to 5 times of the weight of the rice, and a weight of a-amylase is 0.3 percent of a weight of the substrate, and then enzymatically digesting the substrate at 90° C. for 1 hour to prepare a first-enzymatic digested mixture;
a second enzymatic digestion step of cooling the first-enzymatic digested mixture after the first enzymatic digestion step to 50° C., and then enzymatically digesting the first-enzymatic digested mixture for about 3.5 hours at a temperature of 50° C. by adding 0.5% saccharogenic amylase to the weight of the substrate to prepare a secondary enzymatically degraded formulation;
a filtration step of inactivating the saccharogenic amylase of the secondary enzymatically degraded formulation at a temperature of 90° C. for about 0.5 hour, and then filtering the enzyme-inactivated formulation through a filter cloth to separate a sludge comprising rice protein and a filtrate comprising sugar solution;
a rice protein powdering step of homogenizing the sludge obtained by the filtration step and then drying the homogenized sludge to obtain a rice protein powder; and
a rice enzyme extract saccharification solution concentration step of concentrating and sterilizing the filtrate obtained in the filtration step to obtain a rice enzyme digestion extract concentrate

5. The rice milk of claim 2, wherein the rice protein powder and the rice enzyme digestion extract concentrate are prepared by a process comprising:
a first enzymatic digestion step of preparing a mixture comprising a substrate comprised of rice, water and a-amylase, wherein a weight of the water is 3 to 5 times of the weight of the rice, and a weight of a-amylase is 0.3 percent of a weight of the substrate, and then enzymatically digesting the substrate at 90° C. for 1 hour to prepare a first-enzymatic digested mixture;
a second enzymatic digestion step of cooling the first-enzymatic digested mixture after the first enzymatic digestion step to 50° C., and then enzymatically digesting the first-enzymatic digested mixture for about 3.5 hours at a temperature of 50° C. by adding 0.5% saccharogenic amylase to the weight of the substrate to prepare a secondary enzymatically degraded formulation;
a filtration step of inactivating the saccharogenic amylase of the secondary enzymatically degraded formulation at a temperature of 90° C. for about 0.5 hour, and then filtering the enzyme-inactivated formulation through a filter cloth to separate a sludge comprising rice protein and a filtrate comprising sugar solution;
a rice protein powdering step of homogenizing the sludge obtained by the filtration step and then drying the homogenized sludge to obtain a rice protein powder;
a rice enzyme extract saccharification solution concentration step of concentrating and sterilizing the filtrate obtained in the filtration step to obtain a rice enzyme digestion extract concentrate; and
mixing the rice protein powder and the rice enzyme digestion extract concentrate in purified water to prepare the rice milk.

6. A method for producing a rice milk, the method comprising:
a first enzymatic digestion step of preparing a mixture comprising a substrate comprised of rice, water and a-amylase, wherein a weight of the water is 3 to 5 times of the weight of the rice, and a weight of a-amylase is 0.3 percent of a weight of the substrate, and then enzymatically digesting the substrate at 90° C. for 1 hour to prepare a first-enzymatic digested mixture;
a second enzymatic digestion step of cooling the first-enzymatic digested mixture after the first enzymatic digestion step to 50° C., and then enzymatically digesting the first-enzymatic digested mixture for about 3.5 hours at a temperature of 50° C. by adding 0.5% saccharogenic amylase to the weight of the substrate to prepare a secondary enzymatically degraded formulation;
a filtration step of inactivating the saccharogenic amylase of the secondary enzymatically degraded formulation at a temperature of 90° C. for about 0.5 hour, and then filtering the enzyme-inactivated formulation through a filter cloth to separate a sludge comprising rice protein and a filtrate comprising sugar solution;
a rice protein powdering step of homogenizing the sludge obtained by the filtration step and then drying the homogenized sludge to obtain a rice protein powder;
a rice enzyme extract saccharification solution concentration step of concentrating and sterilizing the filtrate obtained in the filtration step to obtain a rice enzyme digestion extract concentrate; and
preparing a mixture comprising the rice protein powder and the rice enzyme digestion extract concentrate in purified water to produce the rice milk.

7. The method of claim 6, wherein the mixture further comprises an enzymatic extract of kelp, seaweed and bamboo leaf, fructooligosaccharide, soy lecithin, vegetable cream, mixed lactobacillus powder, refined salt, citric acid and sodium bicarbonate.

8. The method of claim 6, wherein the mixture comprises the purified water 80 wt %, the rice protein powder 6 wt %, the rice enzyme extract concentrate 10 wt %, the enzymatic extract of kelp, seaweed and bamboo leaf 0.4 wt %, the fructooligosaccharide 0.6 wt %, the soy lecithin 2 wt %, the vegetable cream 0.3 wt %, the mixed lactobacillus powder 0.15 wt %, the refined salt 0.15 wt %, the citric acid 0.2 wt %, and the sodium hydrogencarbonate 0.2 wt % are mixed and added.
